(19) United States
(12) Patent Application Publication
(10) Pub. No.: US 2016/0070377 A1
(43) Pub. Date: Mar. 10, 2016

(54) LAMINATED PANEL AND METHOD FOR LAMINATING PANEL

(71) Applicants: Xiamen Tianma Micro-Electronics Co., Ltd., Xiamen (CN); Tianma Micro-Electronics Co., Ltd., Shenzhen (CN)

(72) Inventor: Yuanyi TANG, Xiamen (CN)

(21) Appl. No.: 14/602,072

(22) Filed: Jan. 21, 2015

(30) Foreign Application Priority Data
Sep. 4, 2014 (CN) 201410448924.8

(51) Int. Cl. G06F 3/041; B32B 37/18; B32B 7/12; B32B 37/12

(52) U.S. Cl. CPC G06F 3/041; B32B 37/12; B32B 37/18; B32B 7/12; B32B 2375/00; B32B 2323/16; B32B 2457/20; B32B 2457/208

(57) ABSTRACT

A laminated panel is disclosed. The laminated panel includes a first substrate, a second substrate, and a frame material. The frame material includes a plurality of pores. The first substrate, the second substrate, and the frame material encompass an accommodation chamber, and the first substrate and the second substrate are adhered to each other with a liquid adhesive in the accommodation chamber. In addition, a border frame for the accommodation chamber is formed by the frame material.

### CROSS-REFERENCES TO RELATED APPLICATIONS

This application claims the benefit of priority to Chinese Patent Application No. 201410448924.8 filed on Sep. 4, 2014 and entitled “LAMINATED PANEL AND METHOD FOR LAMINATING PANEL”, the content of which is incorporated herein by reference in its entirety.

### BACKGROUND OF THE INVENTION

In manufacturing display devices, there are lots of needs for laminating a panel, such as a typical need for laminating a touch panel on a display panel.

For example, to laminate a touch panel on a display panel, a laminating solution adopted in the related art includes: attaching a glue frame onto a display panel so that an accommodation chamber is surrounded by the glue frame on the display panel; injecting an aqueous adhesive into the accommodation chamber on the display panel; placing the touch panel on a side of the display panel onto which the aqueous adhesive is injected, and pressing and laminating the touch panel on the display panel; and solidifying the aqueous adhesive by passing the laminated touch panel and display panel through an aqueous adhesive solidification furnace. In the above method, the glue frame can be alternatively attached to the touch panel and the display panel, further, a height of a gap between the laminated touch panel and display panel is defined by a thickness of the glue frame, thus ensuring the evenness of the height. Moreover, the glue frame may facilitate conveniently controlling the quantity of the injected aqueous adhesive to avoid the overflow of the aqueous adhesive after the laminating.

However, the above method cannot solve the problem of discharging bubbles in the aqueous adhesive. At a normal temperature and normal pressure, bubbles cannot be naturally discharged in the spreading of the liquid, and therefore the bubbles would be remained at a periphery of the accommodation chamber and cannot be discharged. Furthermore, if being solid, the glue frame will resist the touch panel and the display panel, as a result, there might be some area which is not fully filled with the aqueous adhesive; if the glue frame is liquid, the height of the glue frame is unstable, which will lead to an unstable effect of the glue frame in avoiding the overflow of the aqueous adhesive.

### BRIEF SUMMARY OF THE INVENTION

One inventive aspect is a laminated panel, including a first substrate, a second substrate, and a frame material. The frame material includes a plurality of pores. The first substrate, the second substrate, and the frame material encompass an accommodation chamber, and the first substrate and the second substrate are adhered to each other with a liquid adhesive in the accommodation chamber. In addition, a border frame for the accommodation chamber is formed by the frame material.

Another inventive aspect is a method for laminating a panel. The method includes disposing a frame material on a first substrate to form a border frame, the frame material including a plurality of pores. The method also includes applying a liquid adhesive to the first substrate or a second substrate in an area that corresponds to an interior of the border frame, and connecting the first substrate and the second substrate by the liquid adhesive. The method also includes solidifying the liquid adhesive to laminate the first substrate to the second substrate.

### BRIEF DESCRIPTION OF THE DRAWINGS

FIG. 1A is a schematic diagram of a structure of a laminated panel according to an embodiment of the present invention;

FIG. 1B is a transverse cross-sectional view taken along a line EE in FIG. 1A;

FIG. 1C is a longitudinal cross-sectional view taken along a line FF in FIG. 1A;

FIG. 2 is a schematic diagram of an application instance of the laminated panel according to another embodiment of the present invention;

FIG. 3 is an enlarged view of a part of the laminated panel in a block indicated by broken lines in FIG. 2;

FIG. 4 is a schematic diagram of a method for laminating a panel according to still another embodiment of the present invention; and

FIG. 5 is a schematic diagram of a structure of a laminated panel applicable to the laminating method according to an embodiment of the present invention.

### DETAILED DESCRIPTION OF THE PREFERRED EMBODIMENTS

The present disclosure will be further described in detail in combination with the accompanying drawings and embodiments. It is understood that the embodiments described herein are merely used to explain the present disclosure but not to limit the present disclosure. Additionally, it is noted that partial structure relative to the present disclosure instead of the whole structure is illustrated in the drawings for ease of description.

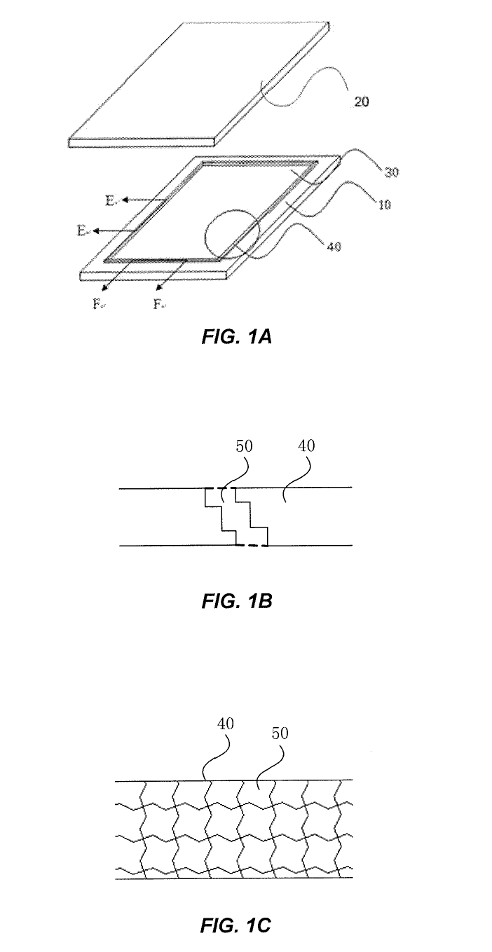

FIG. 1A is a schematic diagram of a structure of a laminated panel according to an embodiment of the present invention. The laminated panel includes a first substrate 10 and a second substrate 20, and further includes an accommodation chamber 30 surrounded by the first substrate 10, the second substrate 20 and a border frame. In the laminated panel, the first substrate 10 and the second substrate are adhered to each other with a liquid adhesive accommodated in the accommodation chamber 30, and the border frame 40 for the accommodation chamber 30 is formed by frame material with pores 50, as illustrated in FIG. 1B and FIG. 1C.

In the laminated panel according to the embodiment of the present invention, the first substrate and the second substrate are two arbitrary substrates to be laminated with a liquid adhesive. For example, the first substrate is a touch panel, and the second substrate is a display panel; or the first substrate is a display panel, and the second substrate is a touch panel.

In order to laminate the above two substrates, the border frame formed by the frame material is disposed between the first substrate and the second substrate to form the accommodation chamber of a required shape. The border frame for the accommodation chamber is typically disposed at edges of the first substrate or the second substrate, which is typically rectangular. Then the liquid adhesive is applied in the accommodation chamber, and the liquid adhesive is solidified after laminating the first and second substrates, thereby finally laminating and fixing the first and second substrates together. The liquid adhesive may be any one or a combination of at least two of a UV adhesive, a hot melt adhesive, a wet solidify adhesive and a bi-component adhesive. The UV adhesive, which is also referred to as shadowless adhesive, photosensitive adhesive, or ultraviolet light curing adhesive, refers to a type of adhesive solidifiable by illuminating of the ultraviolet light, which may be used as an adhesive agent. AB adhesive is a bi-component adhesive, and commonly contains Acrylic and Epoxy components and polyurethane, for example. The AB adhesive refers to a solidifiable adhesive formed by two liquids, i.e. a base adhesive and a hardener, and solidification occurs when the base adhesive and the hardener are mixed independently of temperature, thus the AB adhesive is a kind of adhesive solidifiable under a normal temperature.

In the embodiment of the present invention, the border frame of the accommodation chamber is formed by a frame material with pores, and the pores in the border frame are used to discharge bubbles in the liquid adhesive. Further, the border frame with pores contains spaces compressible to a certain extent, and hence can better match the height of the gap between the first and second substrates, to form an frame with a more even thickness, therefore the liquid adhesive can be fully filled in the accommodation chamber to the maximum extent in the applying process of the liquid adhesive, and a partial overflow of the adhesive caused by the uneven thickness of the frame will not occur.

The frame material with pores may be made of various kinds of materials, preferably of a foam which may be made by foaming polyurethane or ethylene propylene diene monomer (EPDM). The polyurethane foam with micro pores may quickly rebound and possess a good compression property, a high resilience property, a moisture resistance property and a chemical resistance property.

Preferably, the exterior and interior of the accommodation chamber 30 are communicated with each other via the pores 50 in the border frame, as illustrated in FIG. 1B, to discharge bubbles in the liquid adhesive to the exterior of the accommodation chamber 30. Moreover, the pores 50 are oriented in a direction perpendicular to the first substrate and the second substrate, as illustrated in FIG. 1C, so as to make the borderframe 40 compressible ands tretchable in the direction perpendicular to the first substrate and the second substrate, so that the border frame 40 may be adapted to the height of the gap between the first and second substrates, to better laminate the first and second substrates at both sides of the border frame.

A density of the pores in the frame material is 10%-30%, for a better effect of avoiding overflow of the adhesive and discharging bubbles. The effect of avoiding overflow of the adhesive is directly affected by the density of the pores. Additionally, a width of each side constituting the frame may be larger than 0.5 millimeters, typically about 1 millimeter, which depends on the dimension of a margin at the edge of the substrate while preventing an effect on the displaying by the center part of substrate. Preferably, the thickness of the border frame is between 0.3 millimeters and 0.5 millimeters, which is typically slightly larger than the height of the gap between the first and second substrates so that the border frame may be compressed to be adapted to the lamination of the first and second substrates.

In order to facilitate attachment of the border frame to the substrate, surfaces of the border frame for the accommodation chamber respectively toward the first substrate and the second substrate are provided with double-sided adhesive strips, or the double-sided adhesive strip is merely adhered to one of the first and second substrates, to fix the border frame and the substrates. The thickness of the double-sided adhesive strip may preferably be 0.05 millimeters. With the adhered double-sided adhesive strip, the foam constituting the border frame may be supported by the double-sided adhesive strip to ensure the flatness of the adhered foam, thus making the adhered foam be suitable for various cutting processes. For example, the foam may be adhered to a polyethylene terephthalate film (PET-film) layer and then cut into a plurality of border frames one time, with protection film layers being added on upper and lower surfaces thereof, obtaining for example a structure including a light release film, the foam, the double-sided adhesive strip, a heavy release film and the protection film layer from bottom to top, thus the designed shape of the foam may be maintained to facilitate transport and manipulation of the foam.

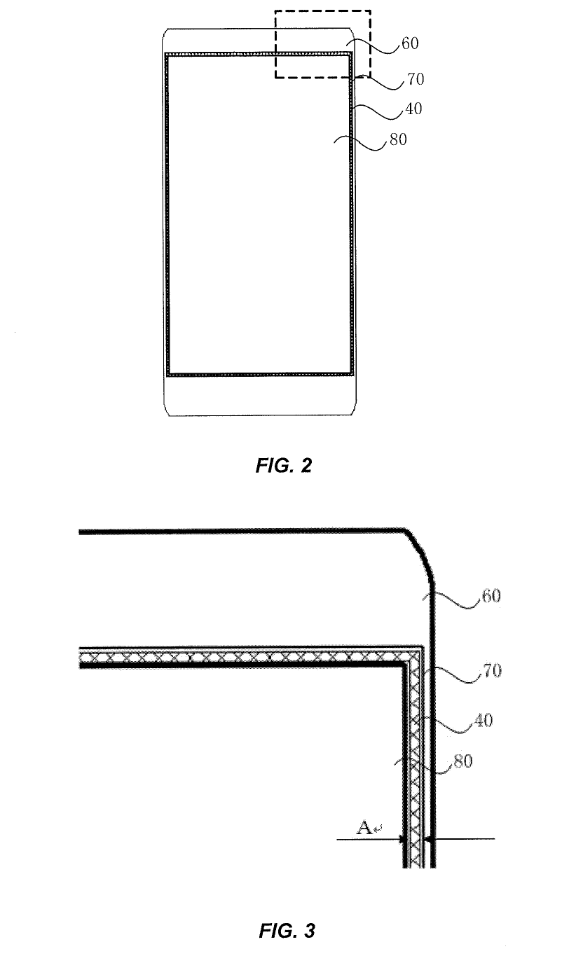

According to another embodiment of the present invention, an application example of the laminated panel in a specific mobile phone with a liquid crystal display screen and a touch panel is provided, as illustrated in FIG. 2, where a touch panel 60 or a glass substrate for carrying the touch panel needs to be laminated on a liquid crystal display screen 70. As illustrated in FIG. 3 which is an enlarged view of a part of the laminated panel in a block indicated by broken lines in FIG. 2, a border frame 40 is provided on the surface of the touch panel 60 or the glass substrate, and then a liquid adhesive is applied to an area 80 corresponding to the interior of the border frame 40, subsequently the border frame 40 is covered by the liquid crystal display screen 70, and the liquid adhesive is solidified to laminate the liquid crystal display screen 70 to the touch panel 60 or the glass substrate.

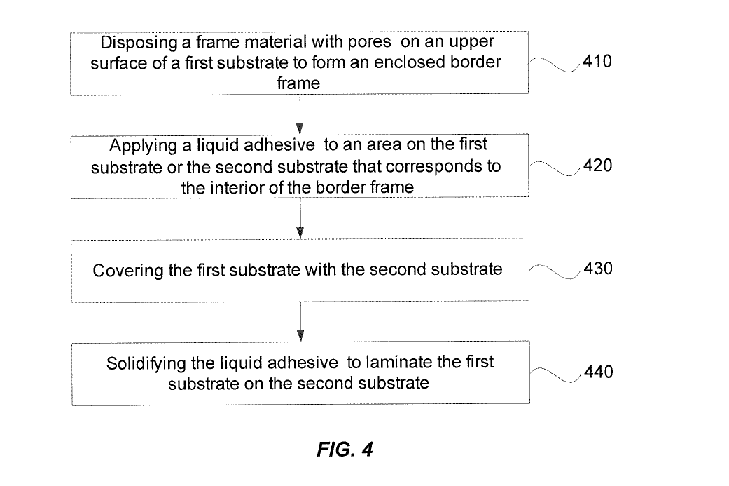

According to still another embodiment of the present invention, a method for laminating a panel is provided, as illustrated in FIG. 4, and the method includes Steps 410 to 440 below.

At Step 410, a frame material with poresis disposed on an upper surface of a first substrate to form an enclosed border frame.

A density of the pores in the frame material is 10%-30%, for a better effect of avoiding overflow of the adhesive and discharging bubbles.

The frame material with pores is preferably a foam, the density of pores in which directly affects the effect of avoiding overflow of the adhesive. The foam may be made by foaming polyurethane or ethylene propylene diene monomer, where the polyurethane foam with micro pores may quickly rebound and possess a good compression property, a high resilience property, a moisture resistance property and a chemical resistance property.

The arrangement of the pores is not limited, but preferably the pores are arranged such that the exterior and interior of the accommodation chamber are communicated with each other via the pores, thereby discharging bubbles in the liquid adhesive to the exterior of the accommodation chamber via the pores. On the other hand, the pores are preferably oriented in a direction perpendicular to the first substrate and the second substrate so that the foam may be compressible and extendable in the direction perpendicular to the substrates.

In the operation of Step 410, surfaces of the frame material with the pores respectively toward the first substrate and the second substrate are provided with double-sided adhesive strips; as such, the frame material is disposed on a surface of the first substrate to form the enclosed border frame.

At Step 420, a liquid adhesive is applied to an area on the first substrate or the second substrate that corresponds to the interior of the border frame.

The liquid adhesive may be one or a combination of at least two of a UV adhesive, a hot melt adhesive, a wet solidify adhesive and a bi-component adhesive. The operation of applying the liquid adhesive may be either applying the liquid adhesive in the interior of the border frame on the first substrate, or applying the liquid adhesive to an area(referring to a transparent area surrounded by the frame material) on the second substrate (without the formed border frame) that corresponds to the interior of the border frame.

At Step 430, the first substrate is covered with the second substrate.

The first substrate may be a touch panel, and the second substrate may be a display panel; or the first substrate is a display panel, and the second substrate is a touch panel. Of course, the technical solutions of the embodiments of the disclosure are applicable to any other substrates to be laminated together by the liquid adhesive.

In this operation, the second substrate is placed on the first substrate on which the liquid adhesive is applied, or the first substrate is placed on the second substrate on which the liquid adhesive is applied.

At Step 440, the liquid adhesive is solidified to laminate the first substrate on the second substrate.

The method according to the embodiment of the present invention may be used to obtain the laminated panel according to the embodiment of the present invention. In the method, the frame material with micro pores such as a foam may possess an absorbing effect to avoid the overflow of the adhesive, so that the overflow of the liquid adhesive may be reduced after the laminating, thereby reducing the work load of cleaning the overflowed adhesive. At the same time, the discharge of bubbles may be effectively ensured. The numerous pores in the foam are stacked, thus the foam may be compressible and extendable to a certain extent, thereby avoiding the case that the adhesive is hard to flow to some area inside the accommodation chamber due to the excessively hard frame material. Further, both the liquid adhesive and the foam are used for adhering, to not only ensure the adhesion stress and the penetrativity, but also avoid the overflow of the adhesive, thereby overcoming the defect that the extending range of the applied liquid adhesive is hard to control due to the high liquidity of the liquid adhesive.

A width of each side of the border frame for the accommodation chamber has an essential influence on the effect of the border frame in avoiding the overflow of the adhesive and discharging the bubbles. In practice, the width of the side of the border frame for the accommodation chamber and a controlled application amount of the applied liquid adhesive meet the following formula:

D>A×B/C

where A represents the width of the side of the border frame; B represents a density of the pores; C represents the minimum distance between a center line of the accommodation chamber and the side of the border frame for the accommodation chamber; and D represents the controlled application amount.

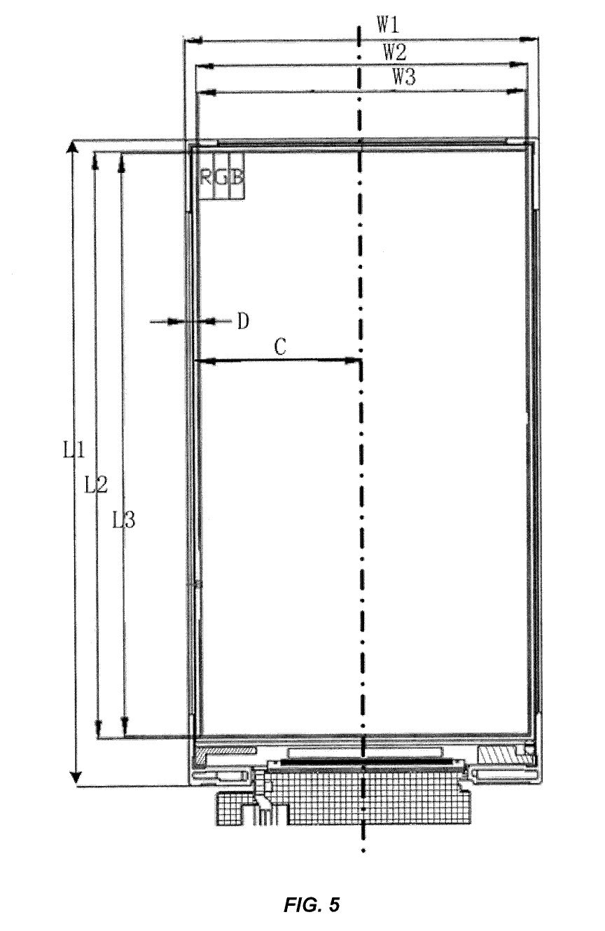

A mobile phone with a high-definition (HD) screen in 4.5 inch is taken as an example to explain the above formula. Referring to FIG. 5, the width of the liquid crystal display screen is indicated by W1, the length of the liquid crystal display screen is indicated by L1; the width of the visual area is indicated by W2, the length of the visual area is indicated by L2; the width of the working area of the liquid crystal display screen is indicated by W3, and the length of the liquid crystal display screen is indicated by L3. The width of the margin at the periphery of the visual area is indicated by D, and a distance between the visual area and the central line, i.e. the minimum distance between the central line of the accommodation chamber and the side of the border frame for the accommodation chamber is indicated by C.

After the foam is manufactured and then cut into the border frames, the width A of the side of the border frame and the density B of the pores are determined. Further, since the product (e.g. the screen) normally possesses its determined dimension, the minimum distance C between the central line of the accommodation chamber and the side of the border frame for the accommodation chamber is determined. Furthermore, an adhesive applying controller, which has an error of 0.2% in the controlled amount of the applied liquid adhesive, is adopted to achieve the overflow control of the liquid adhesive. As for the error of 0.2% of the adhesive applying controller in the amount of the applied adhesive, if the amount of the adhesive intended to be applied in unit time is controlled to be 1 g, the actual amount of the applied adhesive would be from 0.008 to 1.002 g. The control of the overflow of the liquid adhesive refers to the control of the controlled application amount D to meet the formula D>A×B/C, so that the foam material and the size of the foam fit with the size of the product.

Or, given the controlled application amount D of the adhesive applying controller and the minimum distance C between a center line of the accommodation chamber and the side of the border frame for the accommodation chamber, it is possible to control or select the width A of the side of the border frame and the density B of the pores to satisfy the formula D>A×B/C, so that the foam material and the size of the foam fit with the size of the product.

It is noted that the above descriptions are merely for the preferable embodiments and the adopted technical principle of the present invention. The skilled person in the art will understand that the present invention is not limited to those specific embodiments, and various modifications, variations and replacement may be made on the present invention by one of ordinary skills in the art without departing from the spirit and scope of the invention. Therefore, although the present invention is described in detail through above embodiments, the present invention is not limited to those above embodiments, other equivalents may be included in the present invention without departing from the concept of the invention, and the scope of the invention is defined by the accompanied claims.

In the present disclosure, the border frame 40 refers to the foam, and also refers to the frame material.

What is claimed is:

1. A laminated panel, comprising:
a first substrate;
a second substrate; and
a frame material, the frame material comprising a plurality of pores,
wherein the first substrate, the second substrate, and the frame material encompass an accommodation chamber,
wherein the first substrate and the second substrate are adhered to each other with a liquid adhesive in the accommodation chamber,
and wherein a border frame for the accommodation chamber is formed by the frame material.

2. The laminated panel according to claim 1, wherein the frame material comprises foam.

3. The laminated panel according to claim 2, wherein the foam comprises at least one of polyurethane and ethylene propylene diene monomer.

4. The laminated panel according to claim 1, wherein the liquid adhesive comprises at least one of a UV adhesive, a hot melt adhesive, a wet solidify adhesive, and a bi-component adhesive.

5. The laminated panel according to claim 1, wherein an exterior and an interior of the accommodation chamber are connected by the pores, and wherein the pores are configured to transmit bubbles in the liquid adhesive from the interior to the exterior of the accommodation chamber.

6. The laminated panel according to claim 5, wherein the pores are oriented in a direction perpendicular to the first substrate and the second substrate.

7. The laminated panel according to claim 1, wherein a density of the pores in the frame material is 10%-30%.

8. The laminated panel according to claim 1, wherein surfaces of the border frame facing the first substrate and the second substrate are provided with double-sided adhesive strips.

9. The laminated panel according to claim 1, wherein:
the first substrate comprises a touch panel and the second substrate comprises a display panel; or
the first substrate comprises a display panel and the second substrate comprises a touch panel.

10. A method for laminating a panel, comprising:
disposing a frame material on a first substrate to form a border frame, the frame material comprising a plurality of pores;
applying a liquid adhesive to the first substrate or a second substrate in an area that corresponds to an interior of the border frame;
connecting the first substrate and the second substrate by the liquid adhesive; and
solidifying the liquid adhesive to laminate the first substrate to the second substrate.

11. The method according to claim 10, wherein the frame material comprises foam.

12. The method according to claim 11, wherein the foam comprises at least one of polyurethane and ethylene propylene diene monomer.

13. The method according to claim 10, wherein the liquid adhesive comprises at least one of a UV adhesive, a hot melt adhesive, a wet solidify adhesive, and a bi-component adhesive.

14. The method according to claim 10, wherein a width of each side of the border frame is controlled according to a formula of:
D>A×B/C,
wherein A represents the width of the side of the border frame, B represents a density of the pores, C represents the minimum distance between a center line of the border frame, and D represents the controlled application amount.

15. The method according to claim 10, wherein the frame material encompasses an accommodation chamber, and an exterior and an interior of the accommodation chamber are connected by the pores, and wherein the pores are configured to transmit bubbles in the liquid adhesive from the interior to the exterior of the accommodation chamber.

16. The method according to claim 10, wherein the pores are oriented in a direction perpendicular to the first substrate and the second substrate.

17. The method according to claim 10, wherein a density of the pores in the frame material is 10%-30%.

18. The method according to claim 10, wherein disposing the frame material comprises:
providing double-sided adhesive strips on surfaces of the frame material facing the first substrate and the second substrate; and
disposing the frame material on an upper surface of the first substrate to form the enclosed border frame.
